(19) United States
(12) Patent Application Publication
(10) Pub. No.: US 2026/0243308 A1
(43) Pub. Date: Aug. 20, 2026

(54) ROLLING BEARING, AND ROLLING BEARING DIAGNOSTIC DEVICE

(71) Applicants: Mitsubishi Electric Corporation, Tokyo (JP); Mitsubishi Electric Building Solutions Corporation, Tokyo (JP)

(72) Inventors: Naokatsu TAKARA, Tokyo (JP); Hidenori NAGAHAMA, Tokyo (JP); Yu SAITO, Tokyo (JP); Yasuki KIMURA, Tokyo (JP); Shuhei NIIKURA, Tokyo (JP)

(73) Assignees: Mitsubishi Electric Corporation, Tokyo (JP); Mitsubishi Electric Building Solutions Corporation, Tokyo (JP)

(21) Appl. No.: 19/152,464

(22) PCT Filed: Apr. 5, 2023
(86) PCT No.: PCT/JP2023/014140

§ 371 Date: Jul. 31, 2025

(51) Int. Cl. F16C 41/00; F16C 19/52; G01M 13/045

(52) U.S. Cl. CPC F16C 41/00; F16C 19/527; G01M 13/045; F16C 2233/00

(57) ABSTRACT

The diagnostic device includes a behavior sensor, a first calculation unit, and a diagnosis unit. The behavior sensor is provided on a housing. The first calculation unit calculates an evaluation speed based on information acquired by the behavior sensor. The evaluation speed is a total value of a maximum speed component in a direction in which a load from a rotation shaft acts and a maximum speed component in a direction opposite to the direction in which the load from the rotation shaft acts within a period equal to or longer than a cycle Tr of characteristic vibration determined by specifications of the rolling bearing. The diagnosis unit diagnoses damage to the rolling bearing by using an evaluation index based on the evaluation speed calculated by the first calculation unit.

### TECHNICAL FIELD

The present disclosure relates to a rolling bearing, and a diagnostic device of the rolling bearing.

### BACKGROUND ART

PTL 1 discloses an example of a diagnostic device of a rolling bearing. The diagnostic device includes a vibration sensor and a damage and deterioration diagnosis unit. The vibration sensor is attached in contact with a housing of a rolling bearing. The damage and deterioration diagnosis unit diagnoses damage or deterioration of the rolling bearing based on an amplitude of an output signal from the vibration sensor.

### CITATION LIST

### Patent Literature

[PTL 1] JP H6-45215 Y

### SUMMARY OF THE INVENTION

### Problem to be Solved by the Invention

The diagnostic device of PTL 1 detects vibrations that are generated when rolling elements of the rolling baring pass through a damaged portion, based on the amplitude of the output signal from the vibration sensor, and performs diagnosis a degree of the damage. On the other hand, the vibration amplitude is greatly affected by a shape of a damaged corner portion of the rolling bearing, and thus, there is a possibility that the diagnostic device cannot diagnose a size of the damage itself with high accuracy.

The present disclosure solves such a problem. The present disclosure provides a rolling bearing and a diagnostic device of the rolling bearing that can further improve diagnosis accuracy of damage.

### Means to Solve the Problem

A diagnostic device according to the present disclosure is the diagnostic device that diagnoses a rolling bearing which includes an inner ring, an outer ring arranged concentrically with the inner ring, and a plurality of rolling elements arranged between a raceway surface of the outer ring and a raceway surface of the inner ring, and each rolling in association with rotation of the inner ring, rotation of the outer ring, or rotation of both the inner ring and the outer ring, wherein the diagnostic device includes a behavior sensor that is provided on a housing that holds the inner ring or the outer ring and measures behavior of the housing, a first calculation unit that calculates an evaluation speed based on information acquired by the behavior sensor, the evaluation speed being a total value of a maximum speed component in a direction of a load acting from a rotation shaft, which rotates in an integrated manner with the inner ring or the outer ring, and a maximum speed component in a direction opposite to the direction of the load acting from the rotation shaft, within a period equal to or longer than a cycle of characteristic vibration determined by specifications of the rolling bearing; and a diagnosis unit that diagnoses damage to the rolling bearing by using an evaluation index based on the evaluation speed.

A rolling according to the present disclosure includes an inner ring, an outer ring arranged concentrically with the inner ring, a plurality of rolling elements arranged between a raceway surface of the outer ring and a raceway surface of the inner ring and each rolling in association with rotation of the inner ring, rotation of the outer ring, or rotation of both the inner ring and the outer ring, and the above-mentioned diagnostic device.

### Advantageous Effects of the Invention

According to the rolling bearing or the diagnostic device of the rolling bearing according to the present disclosure, it is possible to further improve diagnosis accuracy of damage.

### BRIEF DESCRIPTION OF DRAWINGS

FIG. 1 is a configuration diagram of a rolling bearing according to a first embodiment.

FIG. 2 is a diagram for explaining an example of diagnosis of damage to the rolling bearing by a diagnostic device according to the first embodiment.

FIG. 3 is a diagram for explaining another example of diagnosis of damage to the rolling bearing by the diagnostic device according to the first embodiment.

FIG. 4 is a configuration diagram of a rolling bearing according to a second embodiment.

FIG. 5 is a diagram for explaining an example of diagnosis of damage to a rolling bearing by a diagnostic device according to a third embodiment.

FIG. 6 is a configuration diagram of a rolling bearing according to a seventh embodiment.

FIG. 7 is a diagram illustrating an example of a hardware configuration of a control unit of the diagnostic device according to any one of the first to the eighth embodiments.

### DESCRIPTION OF EMBODIMENTS

Modes for carrying out the subject of the present disclosure will be described with reference to the accompanying drawings. In respective drawings, the same or corresponding portions are denoted by the same reference numerals, and redundant description will be simplified or omitted as appropriate.

### First Embodiment

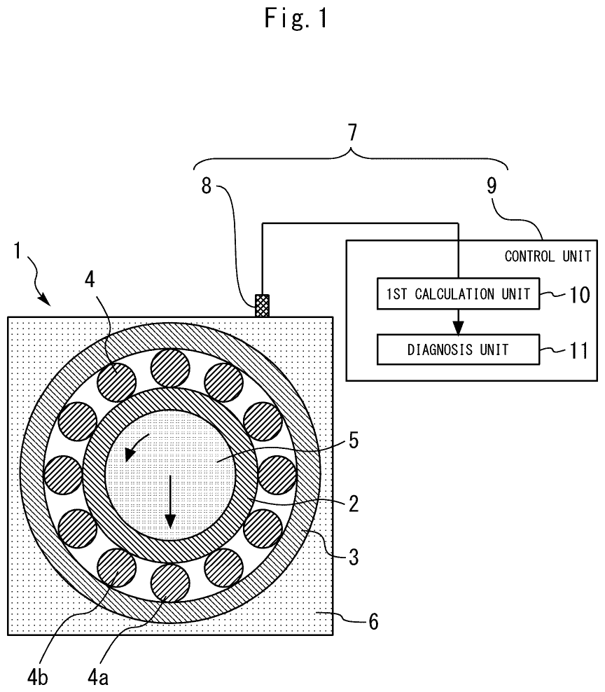

FIG. 1 is a configuration diagram of a rolling bearing according to a first embodiment.

A rolling bearing 1 includes an inner ring 2, an outer ring 3, a plurality of rolling elements 4, and a rotation shaft 5. In FIG. 1, a section of the rolling bearing 1 along a plane perpendicular to a shaft core of the rotation shaft 5 is illustrated. The inner ring 2 has a cylindrical shape. The outer ring 3 has a cylindrical shape. The outer ring 3 is arranged concentrically with the inner ring 2 outside the inner ring 2. The plurality of rolling elements 4 is arranged between the inner ring 2 and the outer ring 3. Each of the rolling elements 4 has a rollable shape such as a spherical shape or a columnar shape. The rolling elements 4 are arranged between a raceway surface that is an inner peripheral surface of the outer ring 3 and a raceway surface that is an outer peripheral surface of the inner ring 2. The rolling elements 4 roll in association with rotation of the inner ring 2, rotation of the outer ring 3 or rotation of both the inner ring 2 and the outer ring 3. Here, in a case where individual rolling elements 4 are distinguished from each other, one of the plurality of rolling elements 4 may be described as a rolling element 4a, a rolling element 4b, or the like.

The rotation shaft 5 rotates in an integrated manner with the inner ring 2 or the outer ring 3. The rotation shaft 5 in this example rotates counterclockwise on paper in FIG. 1. Here, a shaft direction along the shaft core of the rotation shaft 5, that is, an extending direction of the rotation shaft 5 may be simply referred to as a shaft direction. Further, a circumferential direction around the shaft core of the rotation shaft 5, that is, a rotation direction of the rotation shaft 5 may be simply referred to as a circumferential direction. Still further, a direction toward an outside of the rotation shaft 5 from the shaft core of the rotation shaft 5 may be simply referred to as a radial direction.

In the rolling bearing 1 in this example, the inner ring 2 rotates in an integrated manner with the rotation shaft 5, and the outer ring 3 is fixed. Note that in the rolling bearing 1, the outer ring 3 may rotate in an integrated manner with the rotation shaft 5, and the inner ring 2 may be fixed. Further, the rolling bearing 1 may be configured so that both the inner ring 2 and the outer ring 3 rotate.

The rolling bearing 1 is held in a housing 6. The housing 6 holds the inner ring 2 or the outer ring 3 of the rolling bearing 1.

In the rolling bearing 1, a diagnostic device 7 is applied. The diagnostic device 7 has a function of diagnosing a condition of damage, and the like, of the rolling bearing 1. The diagnostic device 7 may be a device included as part of rotation equipment such as a motor, in which the rolling bearing 1 is provided, or may be an external device to be externally applied to the rotation equipment. The diagnostic device 7 may be a device provided all the time in the rolling bearing 1 or rotation equipment in which the rolling bearing 1 is provided or may be a device temporarily provided as a portable device in the rolling bearing 1 or the rotation equipment in which the rolling bearing 1 is provided. The diagnostic device 7 includes a behavior sensor 8 and a control unit 9.

The behavior sensor 8 is attached to the housing 6. The behavior sensor 8 is a sensor that measures behavior of the housing 6. The behavior sensor 8 is, for example, an acceleration sensor, a displacement sensor, a speed sensor, or the like.

The control unit 9 has a function of performing data processing in the diagnostic device 7. The control unit 9 may include one or more pieces of independent hardware or may be part of other hardware such as control equipment of the rotation equipment in which the rolling bearing 1 is provided. The control unit 9 includes a first calculation unit 10 and a diagnosis unit 11.

The first calculation unit 10 is a portion having a function of calculating an evaluation speed to be used for diagnosis of the rolling bearing 1. The evaluation speed is calculated for a period equal to or longer than a cycle Tr of characteristic vibration determined by specifications of the rolling bearing 1. The evaluation speed is a total value of a maximum speed component in a direction in which a load from the rotation shaft 5 acts, and a maximum speed component in a direction opposite to the direction in which the load from the rotation shaft 5 acts within the period. The direction in which the load from the rotation shaft 5 acts is, for example, an outward direction in the radial direction or a downward direction in a vertical direction. In this event, the direction opposite to the direction in which the load from the rotation shaft 5 acts is an inward direction in the radial direction or an upward direction in the vertical direction. Here, the direction in which the load from the rotation shaft 5 acts and the direction opposite to the direction in which the load from the rotation shaft 5 acts may be respectively expressed as a load direction and an anti-load direction.

The first calculation unit 10 calculates the evaluation speed by processing an output signal from the behavior sensor 8. For example, in a case where the behavior sensor 8 is a speed sensor, the first calculation unit 10 calculates the evaluation speed using time-series data of a speed that is the output signal from the behavior sensor 8. Further, in a case where the behavior sensor 8 is an acceleration sensor, the first calculation unit 10 performs time integration on time-series data of an acceleration that is the output signal from the behavior sensor 8 to calculate time-series data of the speed. In this event, the first calculation unit 10 calculates the evaluation speed using the calculated time-series data of the speed. Further, in a case where the behavior sensor 8 is a displacement sensor, the first calculation unit 10 differentiates with respect to time, time-series data of a displacement that is the output signal from the behavior sensor 8 to calculate time-series data of the speed. In this event, the first calculation unit 10 calculates the evaluation speed using the calculated time-series data of the speed.

The first calculation unit 10 calculates a maximum speed component in the direction in which the load from the rotation shaft 5 acts from the time-series data of the speed for a period set in advance, equal to or longer than a cycle Tr. The first calculation unit calculates a maximum speed component in the direction opposite to the direction in which the load from the rotation shaft 5 acts from the time-serries data of the speed for the period. The first calculation unit 10 calculates the evaluation speed by adding absolute values of these two maximum speed components.

The diagnosis unit 11 is a portion having a function of diagnosing damage to the rolling bearing 1 by using an evaluation index based on the evaluation speed calculated by the first calculation unit 10. In this example, the diagnosis unit 11 diagnoses the damage to the rolling bearing 1 using the evaluation speed itself calculated by the first calculation unit 10 as the evaluation index. The diagnosis unit 11, for example, provides a diagnose that damage has occurred to the rolling bearing 1 in a case where the evaluation speed exceeds a threshold set in advance.

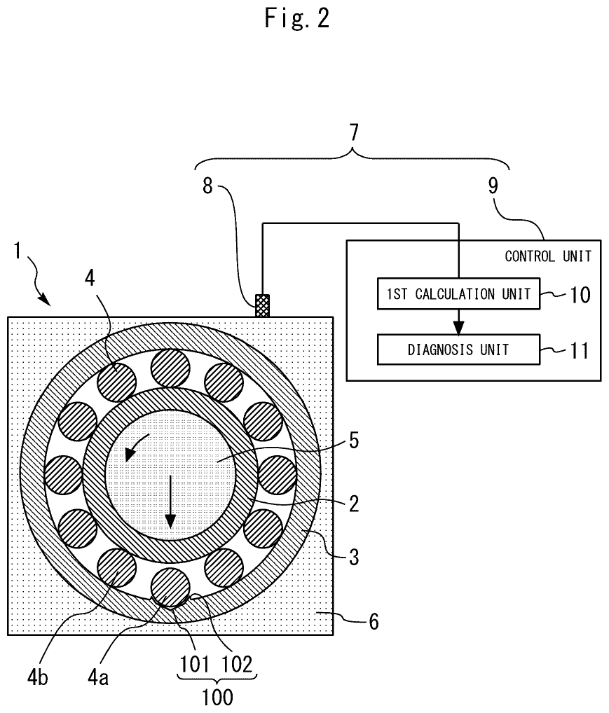

Subsequently, an example of diagnosis of damage to the rolling bearing 1 by the diagnostic device 7 will be described using FIG. 2.

FIG. 2 is a diagram for explaining an example of diagnosis of the damage to the rolling bearing by the diagnostic device according to the first embodiment.

In FIG. 2, a damaged portion 100 is illustrated as an example of damage that can occur to the rolling bearing 1. The damaged portion 100 occurs in the rolling bearing 1, for example, as follows.

In the rolling bearing 1 in this example, the rotation shaft 5 rotates counterclockwise on paper in an integrated manner with the inner ring 2. In this event, each rolling element 4 in contact with the raceway surface of the inner ring 2 rotationally moves so as to revolve around a central axis of the rotation shaft 5 between the inner ring 2 and the outer ring 3 counterclockwise on paper while rotating around a central point of the rolling element 4 itself clockwise on paper in association with rotation of the inner ring 2. In a case where a load on the inner ring 2 due to a load, and the like, of the rotation shaft 5 acts in a lower part on paper, most of the load from the rotation shaft 5 is transmitted to the raceway surface of the inner ring 2, and the raceway surface of the outer ring 3 via the plurality of rolling elements 4, and the like, located below the rotation shaft 5. When the rotation shaft 5 stands still, a position and a magnitude of load occurring in each of the inner ring 2, the outer ring 3 and the rolling elements 4 do not change. On the other hand, when the rotation shaft 5 rotates, the position and the magnitude of the load periodically change in association with rotational movement of the inner ring 2 and the rolling elements 4. By this means, repetitive stress loads act on the raceway surfaces of the inner ring 2 and the outer ring 3. Due to such repetitive stress loads, for example, a crack which originates from impurities inside a material, may make progress from an inside of the inner ring 2, the outer ring 3, or the like, and reach a surface. In this event, an internally-originating flaking-off damage that is scalelike flaking off of a surface zone can occur on the raceway surface, or the like, of the inner ring 2 or the outer ring 3.

Further, abnormal slipping may occur between the rolling element 4, and the inner ring 2 and the outer ring 3 due to poor lubrication of the raceway surface caused by insufficient greasing of a lubricant such as grease, deterioration, leak, insufficient viscosity, an excessive load, or the like. In this event, stress is likely to concentrate on a surface of the raceway surface due to rough surface, wear, or the like, of the raceway surface, and damage to the raceway surface may be further accelerated. As an example, a surface-originating flaking-off damage which is scalelike flaking off of a surface zone of part of the raceway surface, a wear damage, or the like, may occur on the raceway surface.

Concerning the internally-originating flaking-off damage, there is a lifespan design formula called L10 life, and specifications of the rolling bearing 1 are normally determined based on the lifespan design formula, and thus, the internally-originating flaking-off damage hardly occurs. On the other hand, the surface-originating flaking-off damage can occur extremely earlier than the internally-originating flaking-off damage, and thus, it is important to diagnose a condition of the rotation equipment to secure reliability and achieve long-term operation of the rolling bearing 1 and the rotation equipment in which the rolling bearing 1 is provided.

According to the knowledge obtained from a bearing test, the damaged portion 100 by the flaking-off damage is often formed on the raceway surface of the rolling bearing 1. Further, the damaged portion 100 is often constituted of a recessed portion 101 and a damaged corner portion 102. It is considered that sizes and shapes of the recessed portion 101 and the damaged corner portion 102 are always changing in accordance with a total number of rotations of the rolling bearing 1. Further, the recessed portion 101 becomes larger as the total number of rotations of the rolling bearing 1 increases. On the other hand, it has been confirmed that the shape of the damaged corner portion 102 is sharp in an initial stage of occurrence of the damage, but thereafter, may change to a smooth shape by wear, and the like. In a case where the damaged portion 100 is caused by the surface-originating flaking-off damage, a depth of the recessed portion 101 is shallow in an initial stage of occurrence of the damage, and thus, the recessed portion 101 becomes larger in a shaft direction and in a circumferential direction and also becomes deeper in a radial direction during progress of the damage.

While instantaneous vibration increases as a result of the shape of the damaged corner portion 102 becoming sharp, lifespans of rolling bearing 1 and the rotation equipment in which the rolling bearing 1 is provided are less affected. On the other hand, the recessed portion 101 becomes larger as the total number of rotations of the rolling bearing 1 increases, which can lead to continuous increase, and the like, of rattling, wobble or abnormal noise of the rolling bearing 1 and the whole rotation equipment in which the rolling bearing 1 is provided. Thus, the size of the recessed portion 101 can largely affect the lifespans of the rolling bearing 1 and the whole rotation equipment in which the rolling bearing 1 is provided.

For example, as illustrated in FIG. 1, consideration will be given to a case where in the inner-ring-rotation-type rolling bearing 1 in which the inner ring 2 rotates along with the rotation shaft 5, the recessed portion 101 is formed on a load side of the outer ring 3. If the recessed portion 101 becomes larger, the rolling element 4 sinks down in the recessed portion 101 at a timing at which the rolling element 4 arrives at the recessed portion 101 upon rotation of the rolling bearing 1. In this event, the rolling element 4 drops in a depth direction of the recessed portion 101 along with the inner ring 2 and the rotation shaft 5. Further, the rolling element 4 rises from a bottom portion of the recessed portion 101 along with the inner ring 2 and the rotation shaft 5 at a timing at which the rolling element 4 goes out from the recessed portion 101. Thus, rattling, wobble and abnormal noise of the rolling bearing 1 and the rotation shaft 5 become larger as the recessed portion 101 is deeper. If the recessed portion 101 becomes too deep, rattling, wobble and abnormal noise of the rolling bearing 1 and the rotation shaft 5 may become extremely large. In this event, there is a case where a design upper limit of the rotation equipment in which the rolling bearing 1 is provided may be exceeded. Further, there is a case where this may lead to a failure such as a crack in or breakage of the rolling bearing 1, a failure of peripheral equipment of the rolling bearing 1, a failure of the whole rotation equipment in which the rolling bearing 1 is provided, and the like.

It is therefore important to diagnose a condition of a size or a degree of the damage to the rolling bearing 1, such as a depth of the recessed portion 101. By diagnosing the condition of the rolling bearing 1, it is possible to detect an abnormality in and estimate a remaining lifespan of the rolling bearing 1, and the like, and perform maintenance and lifespan extension treatment such as replacement of the rolling bearing 1 or grease at an appropriate timing. Further, this makes it possible to save labor of the maintenance and achieve long-term stable operation of the rolling bearing 1, the peripheral equipment of the rolling bearing 1, and the whole rotation equipment in which the rolling bearing 1 is provided.

The diagnostic device 7 diagnoses the damaged portion 100 as illustrated in FIG. 2, for example, as follows. Note that while a case where the damaged portion 100 has occurred in the outer ring 3 is illustrated as an example in FIG. 2, the damaged portion 100 may occur in the inner ring 2 or the rolling element 4.

The first calculation unit 10 calculates an evaluation speed for a period equal to or longer than the cycle Tr of the characteristic vibration determined by the specifications of the rolling bearing 1. The characteristic vibration described here includes not only vibration occurring when the rolling element 4 passes through the damaged portion 100 that has occurred in the outer ring 3 as illustrated in FIG. 2, but also vibration occurring when the rolling element 4 passes through the damaged portion 100 that has occurred in the inner ring 2, and vibration occurring when the inner ring 2 and the outer ring 3 pass through the damaged portion 100 that has occurred in the rolling element 4. Here, among the cycle Tr, a cycle of characteristic vibration originating from damage to the inner ring 2 is defined as Trᵢ [sec], a cycle of characteristic vibration originating from damage to the outer ring 3 is defined as Trₒ [sec], and a cycle of characteristic vibration originating from damage to the rolling element 4 is defined as Tr_{b} [sec]. In a case where damage has occurred to the inner ring 2, the characteristic vibration of the cycle Trᵢ is particularly large, in a case where damage has occurred to the outer ring 3, the characteristic vibration of the cycle Trₒ is particularly large, and in a case where damage has occurred to the rolling element 4, the characteristic vibration of the cycle Tr_{b} is particularly large. For example, in a case where the outer ring 3 has the damaged portion 100 as illustrated in FIG. 2, a period from when the rolling element 4a passes through the damaged portion 100 until when the rolling element 4b passes through the damaged portion 100 becomes the cycle Trₒ. For example, in a case where a diameter of the rolling element 4 is defined as d [mm], a revolution diameter of the rolling element 4 is defined as D [mm], the number of rolling elements 4 is defined as Z, a contact angle of the rolling element 4 is defined as a [rad], and a rotation frequency of the inner ring 2 is defined as fᵣ [sec-1], the cycle Trᵢ of the characteristic vibration originating from damage to the inner ring 2, the cycle Trₒ of the characteristic vibration originating from damage to the outer ring 3, and the cycle Tr_{b} of the characteristic vibration originating from damage to the rolling element 4 are respectively expressed with the following expression (1), expression (2) and expression (3).

$$[ Math . 1 ]$$

$${Tr}_{i} = \frac{2}{{f}_{r} Z} ( \frac{D}{D + d cos α} ) \qquad ( 1 )$$

$$[ Math . 2 ]$$

$${Tr}_{o} = \frac{2}{{f}_{r} Z} ( \frac{D}{D - d cos α} ) \qquad ( 2 )$$

$$[ Math . 3 ]$$

$${Tr}_{b} = \frac{2 d}{{f}_{r} D} ( \frac{{D}^{2}}{{D}^{2} - {d}^{2} {cos}^{2} α} ) \qquad ( 3 )$$

Regardless of a position where the damaged portion 100 has occurred among the inner ring 2, the outer ring 3 and the rolling element 4, behavior of any part sinking down and dropping in the recessed portion 101 of the damaged portion 100 and going out and rising from the recessed portion 101 occurs at least once within a period of the cycle Tr. The first calculation unit 10 calculates a maximum speed component in a direction in which the load from the rotation shaft 5 acts and a maximum speed component in an opposite direction thereof in the period equal to or longer than the cycle Tr using the time-series data of the speed based on the output signal from the behavior sensor 8. The first calculation unit 10 adds absolute values of the two maximum speed components to obtain the evaluation speed. As a result of the diagnosis unit 11 diagnosing damage to the rolling bearing 1 based on the evaluation speed obtained by the first calculation unit 10 in this manner, regardless of a position where the damaged portion 100 has occurred among the inner ring 2, the outer ring 3, and the rolling element 4, the diagnostic device 7 can diagnose a size or a degree of the damaged portion 100 with high accuracy.

Further, the diagnosis unit 11 can provide an abnormality diagnosis indicating that damage has occurred to the rolling bearing 1 in a case where the evaluation speed exceeds a threshold set in advance. Still further, the diagnosis unit 11 can diagnose a size or a degree of the damaged portion 100 such as a depth of the recessed portion 101 with high accuracy by diagnosis based on the evaluation speed.

As described above, the rolling bearing 1 according to the first embodiment includes the inner ring 2, the outer ring 3, the plurality of rolling elements 4, and the diagnostic device 7. The outer ring 3 is arranged concentrically with the inner ring 2. The plurality of rolling elements 4 is arranged between the raceway surface of the outer ring 3 and the raceway surface of the inner ring 2. Each of the rolling elements 4 rolls in association with rotation of the inner ring 2, rotation of the outer ring 3 or rotation of both the inner ring 2 and the outer ring 3. In the rolling bearing 1, the rotation shaft 5 rotates in an integrated manner with the inner ring 2 or the outer ring 3. The diagnostic device 7 includes the behavior sensor 8, the first calculation unit 10, and the diagnosis unit 11. The behavior sensor 8 is provided on the housing 6 that holds the inner ring 2 or the outer ring 3. The behavior sensor 8 measures behavior of the housing 6. The first calculation unit 10 calculates the evaluation speed based on information acquired by the behavior sensor 8. The evaluation speed is a total value of the maximum speed component in a direction in which the load from the rotation shaft 5 acts and the maximum speed component in a direction opposite to the direction in which the load from the rotation shaft 5 acts within a period equal to or longer than the cycle Tr of the characteristic vibration determined by the specifications of the rolling bearing 1. The diagnosis unit 11 diagnoses the damage to the rolling bearing 1 using the evaluation index based on the evaluation speed calculated by the first calculation unit 10.

As a comparative example, consideration will be given to a case where damage to the rolling bearing is diagnosed only based on an amplitude of the vibration of the output signal from the vibration sensor without depending on the evaluation index based on the evaluation speed, unlike with the diagnostic device 7. When the rolling element of the rolling bearing passes through the damaged portion, it is often the case that fine and small vibration occurs a plurality of times. Thus, even if the damaged portion becomes large, the amplitude of the vibration does not become large, and thus, there is a case where the damage cannot be diagnosed with high accuracy only based on the amplitude of the vibration. Further, if a shape of the damaged corner portion of the damaged portion becomes smooth by wear, and the like, the rolling element smoothly passes through the damaged portion, and thus, influence of the damaged portion does not appear in the amplitude of the vibration, and the damage is not detected. Still further, in a case where the shape of the damaged corner portion is sharp even if the recessed portion of the damaged portion is small, there is a case where an instantaneous behavior change may become large at a timing at which the rolling element passes through the damaged corner portion. In this event, vibration, and the like, in which acceleration, and the like, instantaneously increase alternately in the load direction and in the anti-load direction can occur. By this means, an amplitude of the acceleration, and the like, can become large regardless of the size of the recessed portion, and thus, it may be difficult to diagnose the size of the damage itself such as the size of the recessed portion of the damaged portion with high accuracy. Further, the vibration of the rolling bearing can include vibration in a high frequency band caused by friction sliding, and the like. Thus, a magnitude of the vibration can change depending on a lubricated condition of the rolling bearing. For example, if the lubricated condition is deteriorated due to oxidation deterioration of grease that lubricates the rolling bearing, oil separation, leak, destruction of a thickening agent, or the like, there is a case where the vibration increases several times even if damage does not occur to the rolling bearing itself. In this manner, the diagnosis only based on the magnitude of the amplitude of the vibration is affected by a change of the lubricated condition of the rolling bearing, and thus, there is a case where diagnosis accuracy of damage to the rolling bearing may degrade.

On the other hand, the diagnostic device 7 performs diagnosis using the evaluation speed that is a total value of the maximum speed component in the load direction at a timing at which the rolling element 4 sinks down in the recessed portion 101, and the maximum speed component in the anti-load direction at a timing at which the rolling element 4 goes out of the recessed portion 101. Instantaneous behavior occurring when the rolling element 4 passes through the damaged corner portion 102 appears as an instantaneous acceleration amplitude. A speed obtained by integrating such an instantaneous acceleration amplitude hardly becomes large and is relatively smaller than speeds at a timing at which the rolling element 4 sinks down in the recessed portion 101 and at a timing at which the rolling element 4 goes out of the recessed portion 101. Diagnosis is performed using the evaluation speed that is a total value of these speeds, and thus, the diagnostic device 7 can suppress influence of instantaneous behavior of the rolling element 4 by the shape of the damaged corner portion 102 upon diagnosis. Further, both the maximum speed component in the load direction and the maximum speed component in the anti-load direction become larger as the depth of the recessed portion 101 is larger. The diagnostic device 7 that uses the evaluation speed having a strong correlation with the depth of the recessed portion 101 can diagnose the depth of the recessed portion 101 with high accuracy. Further, the evaluation speed becomes large by a geometric shape of the recessed portion 101, and thus, unlike with a device that performs diagnosis based on vibration including a high frequency band caused by friction sliding, the diagnostic device 7 can diagnose the damage to the rolling bearing 1 with high accuracy while suppressing influence of the lubricated condition.

Further, typically, the rolling bearing is a portion to which the largest load is applied in the rotation equipment and that is likely to break down first. If damage occurs to the rolling bearing, there is a case where the damage may become large at an accelerated rate as a result of stress around the damage becoming large. If the damage becomes large, there is a possibility that breakage of the rolling bearing, damage to or breakage of peripheral equipment of the rolling bearing, a severe failure of the whole rotation equipment in which the rolling bearing is provided, and the like, may occur.

Concerning this, the diagnostic device 7 can diagnose the damage to the rolling bearing 1 with high accuracy, so that it is possible to perform preventive maintenance of the rolling bearing 1. This makes it possible to prevent in advance a failure not only in the rolling bearing 1 itself but also in peripheral equipment of the rolling bearing 1 and the whole rotation equipment in which the rolling bearing 1 is provided.

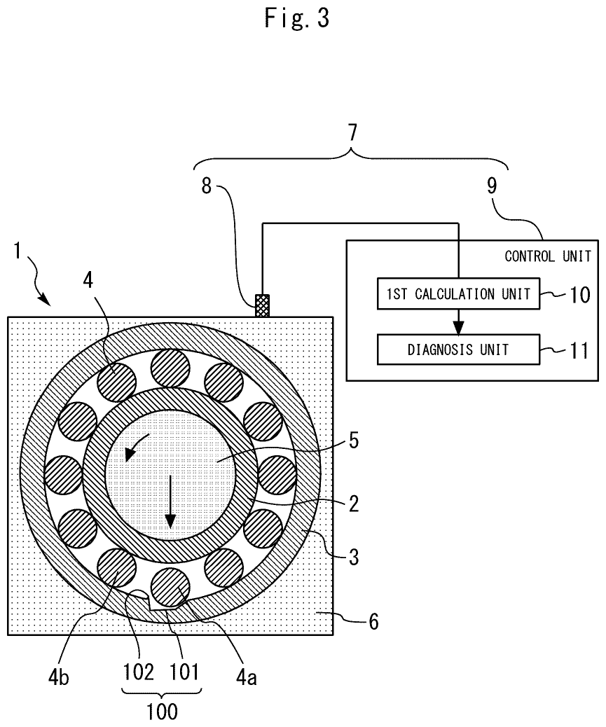

FIG. 3 is a diagram for explaining another example of diagnosis of the damage to the rolling bearing by the diagnostic device according to the first embodiment.

FIG. 3 illustrates the damaged portion 100 having the recessed portion 101 asymmetric in the circumferential direction as another example of the damage that can occur to the rolling bearing 1.

There is a case where in such a damaged portion 100, the maximum speed component in the load direction and the maximum speed component in the anti-load direction are different depending on the rotation direction of the rotation shaft 5. Also in this case, the diagnostic device 7 can diagnose the damage to the rolling bearing 1 with high accuracy regardless of the rotation direction by performing diagnosis using the evaluation speed that is a total value of the maximum speed component in the load direction and the maximum speed component in the anti-load direction. For example, as illustrated in FIG. 3, in the rolling bearing 1 in which the inner ring 2 rotates counterclockwise on paper along with the rotation shaft 5, there is a case where a side opposite to a traveling direction of the rotation direction of the recessed portion 101 of the damaged portion 100 is inclined more sharply than a side of the traveling direction of the rotation direction. In this case, compared to the damaged portion 100 symmetric in the circumferential direction, the maximum speed component in the load direction may become large at a timing at which the rolling element 4 sinks down in the recessed portion 101, and the maximum speed component in the anti-load direction may become small at a timing at which the rolling element 4 goes out of the recessed portion 101. Further, in a case where the rotation shaft 5 rotates backward, the maximum speed component in the load direction may become small at a timing at which the rolling element 4 sinks down in the recessed portion 101, and the maximum speed component in the anti-load direction may become large at a timing at which the rolling element 4 goes out of the recessed portion 101. In other words, there is a case where the maximum speed component in the load direction and the maximum speed component in the anti-load direction may be different from each other in magnitude depending on the rotation direction of the rotation shaft 5 for the same recessed portion 101. On the other hand, a magnitude of the evaluation speed that is a total value of the maximum speed component in the load direction and the maximum speed component in the anti-load direction does not largely change depending on the rotation direction. The diagnostic device 7 performs diagnosis using the evaluation speed, and thus, can diagnose the damage to the rolling bearing 1 with higher accuracy while suppressing influence of the rotation direction of the rotation shaft 5. Particularly, in the rolling bearing 1 to be applied to rotation equipment such as, for example, an elevator, a railroad vehicle, and a generator rotating in both directions, in which the rotation direction can change, the diagnostic device 7 exerts a function capable of performing diagnosis without being affected by the rotation direction more effectively.

In each of embodiments which will be described below, differences from examples disclosed in other embodiments will be particularly described in detail. Concerning features not described in each of the embodiments described below, any features in the examples disclosed in other embodiments may be employed.

### Second Embodiment

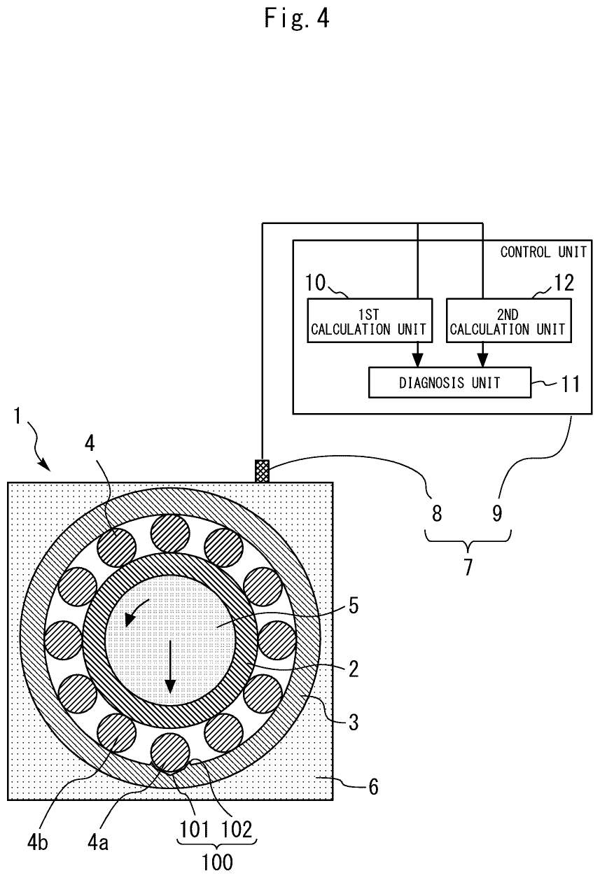

FIG. 4 is a configuration diagram of a rolling bearing according to a second embodiment.

The control unit 9 of the diagnostic device 7 of the rolling bearing 1 includes the first calculation unit 10, a second calculation unit 12, and the diagnosis unit 11. The second calculation unit 12 is a portion having a function of calculating an acceleration frequency spectrum, an acceleration overall value or both of them based on the information acquired by the behavior sensor 8.

The second calculation unit 12 calculates the acceleration frequency spectrum, the acceleration overall value or both of them by processing the output signal from the behavior sensor 8. For example, in a case where the behavior sensor 8 is an acceleration sensor, the second calculation unit 12 calculates the acceleration frequency spectrum, the acceleration overall value or both of them using time-series data of an acceleration that is the output signal from the behavior sensor 8. Further, in a case where the behavior sensor 8 is a speed sensor, the second calculation unit 12 may differentiate with respect to time, time-series data of a speed that is the output signal from the behavior sensor 8 to calculate time-series data of the acceleration. In this event, the second calculation unit 12 calculates the acceleration frequency spectrum, the acceleration overall value or both of them using the calculated time-series data of the acceleration. Further, in a case where the behavior sensor 8 is a displacement sensor, the second calculation unit 12 may differentiate with respect to time, time-series data of a displacement that is the output signal from the behavior sensor 8 twice to calculate time-series data of the acceleration. In this event, the second calculation unit 12 calculates the acceleration frequency spectrum, the acceleration overall value or both of them using the calculated time-series data of the acceleration. The second calculation unit 12 may calculate the acceleration frequency spectrum, the acceleration overall value or both of them, for example, for a period equal to or longer than the cycle Tr for which the evaluation speed is calculated by the first calculation unit 10 or may calculate the acceleration frequency spectrum, the acceleration overall value or both of them for a longer or shorter period.

The acceleration frequency spectrum is a magnitude of an acceleration amplitude spectrum obtained for each frequency band by performing calculation such as Fourie transform on the time-series data of the acceleration acquired using the behavior sensor 8.

The evaluation vibration is an evaluation index calculated based on both the evaluation speed and the acceleration frequency spectrum, and thus, an occurrence position of the damaged portion 100 may be able to be determined as well as the size of the damaged portion 100 is able to be diagnosed with higher accuracy. In particular, use of the acceleration amplitude spectrum in the frequency band of the characteristic vibration, which is an inverse of the cycle of the characteristic vibration of the rolling bearing, makes it possible to grasp characteristic vibration originating from the damage, and the like, in detail for each occurrence position of the damaged portion 100 such as the inner ring, the outer ring or the rolling element. This enables the diagnosis unit 11 to determine a position among the inner ring 2, the outer ring 3 or the rolling element 4 of the rolling bearing 1, where the damaged portion 100 has occurred. Further, the diagnosis unit 11 can diagnosis the size of the damaged portion 100 with high accuracy using information regarding a magnitude of the acceleration amplitude spectrum in the frequency band of the characteristic vibration.

The acceleration overall value is an integrated value of magnitudes of the whole acceleration frequency spectra regardless of the frequency band for information such as the time-series data, and the like, acquired by the behavior sensor 8.

In a case where a minor damage such as wear or rough surface has occurred to the raceway surface, or the like, on which the rolling element 4 rolls, the rolling element 4 hardly sinks down in or goes out of the recessed portion 101. In this event, a rise range of the evaluation speed becomes small. On the other hand, the acceleration overall value is an integrated value of the magnitudes of the whole acceleration frequency spectra regardless of the frequency band, and thus, it considerably rises also by minor wear, rough surface, or the like. The evaluation vibration is an evaluation index calculated based on both the evaluation speed and the acceleration overall value, and thus, the diagnostic device 7 can also diagnose a minor damage such as wear and rough surface with high accuracy.

As described above, the diagnosis unit 11 calculates the evaluation vibration as the evaluation index using the evaluation speed calculated by the first calculation unit 10, and the acceleration frequency spectrum calculated by the second calculation unit 12, the acceleration overall value, or both of them. Further, the diagnosis unit 11, for example, calculates the evaluation vibration by multiplying each of the evaluation speed, and the acceleration frequency spectrum, the acceleration overall value or both of them by a weighting coefficient and adding up the results. Further, the diagnosis unit 11 may, for example, calculate the evaluation vibration by an arithmetic average, a geometric mean or other functions of the evaluation speed, and the acceleration frequency spectrum, the acceleration overall value or both of them. The diagnosis unit 11, for example, provides a diagnosis indicating that damage has occurred to the rolling bearing 1 in a case where the evaluation vibration exceeds a threshold set in advance. Here, the weighting coefficient and the function are determined in advance, for example, using a data analysis method such as regression analysis or a machine learning method which uses as input, data of the evaluation speed, and the acceleration frequency spectrum, the acceleration overall value or both of them calculated for a plurality of rolling bearings 1 for which the size of the damage is known. As a result of the weighting coefficient and the function being determined using the information on the rolling bearings 1 for which the size of the damage is known, a correlation between the evaluation vibration and the size and the occurrence position of the damage becomes strong. This further improves diagnosis accuracy of the damage to the rolling bearing 1 using the evaluation vibration as the evaluation index.

### Third Embodiment

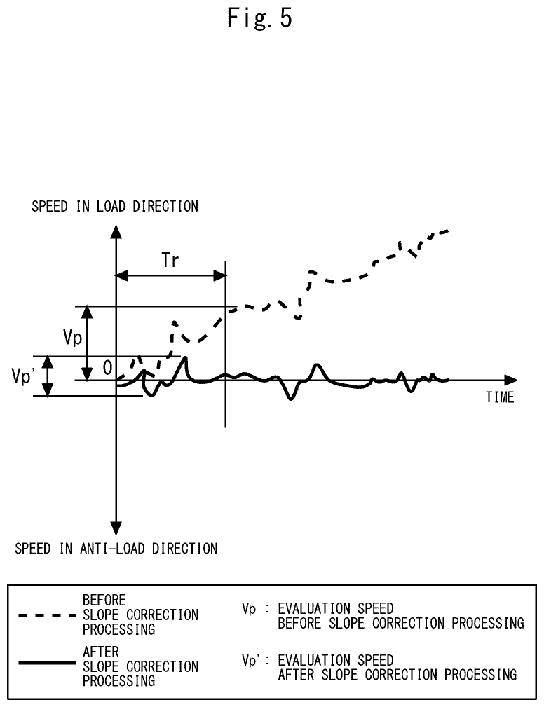

FIG. 5 is a diagram for explaining an example of diagnosis of damage to a rolling bearing by a diagnostic device according to a third embodiment.

FIG. 5 indicates transition of time on a horizontal axis. FIG. 5 indicates a speed acquired by the behavior sensor 8 on a vertical axis. An upper side on the vertical axis indicates the magnitude of a speed in the load direction. On the other hand, a lower side on the vertical axis indicates the magnitude of a speed in the anti-load direction.

For example, in a case where the time-series data of the speed is calculated by performing time integration on the time-series data of the acceleration using the acceleration sensor as the behavior sensor 8, as indicated by a dashed line in FIG. 5, the speed may extremely increase in the load direction over a period equal to or longer than the cycle Tr. This occurs as a result of the time-series data of the acceleration which is the output signal being wholly shifted in the load direction in a case where an attachment condition of the behavior sensor 8 that is the acceleration sensor is poor, in a case where noise such as other turbulence vibration is greatly reflected, or the like. For a similar reason, the speed may increase in the anti-load direction over a period equal to or longer than the cycle Tr.

On the other hand, even if there is a case where minor vibration may occur in the rolling bearing 1 and the housing 6, normally, installation positions of the rolling bearing 1 and the housing 6 do not largely change. Thus, a condition where the speed continues to increase for a long period as indicated by the dashed line in FIG. 5 is different from an actual condition, and if such time-series data is used as is, an evaluation speed Vp is calculated as an excessive value. Thus, the diagnostic device 7 performs slope correction on the time-series data of the speed.

The first calculation unit 10 of the diagnostic device 7 performs slope correction processing on the time-series data of the speed based on the information acquired by the behavior sensor 8. The slope correction processing is performed, for example, by obtaining a slope component of the time-series data of the speed through linear regression or other methods dividing by a period equal to or longer than the cycle Tr and subtracting the obtained slope component from the time-series data of the speed. The first calculation unit 10 calculates an evaluation speed Vp′ for the period equal to or longer than the cycle Tr using the time-series data of the speed subjected to the slope correction processing.

The diagnostic device 7 can diagnose the damage to the rolling bearing 1 without being affected by an attachment condition of the behavior sensor 8 and noise such as turbulence vibration by using the evaluation speed Vp′ calculated in this manner.

### Fourth Embodiment

The first calculation unit 10 of the diagnostic device 7 performs frequency filter processing on the time-series data based on the information acquired by the behavior sensor 8. The first calculation unit 10 performs frequency filter processing on the time-series data of, for example, the acceleration, the speed or the displacement acquired by the behavior sensor 8. The first calculation unit 10 may perform frequency filter processing on the time-series data of the speed derived from the time-series data of the acceleration or the displacement acquired by the behavior sensor 8. Further, the first calculation unit 10 may perform frequency filter processing on both the time-series data acquired by the behavior sensor 8 and the time-series data of the speed derived from the time-series data. The frequency filter processing is, for example, high-pass filter, low-pass filter, bandpass filter or other kinds of filter processing. The first calculation unit 10 calculates the evaluation speed for the period equal to or longer than the cycle Tr using the time-series data of the speed subjected to the frequency filter processing.

Use of the evaluation speed calculated in this manner enables the diagnostic device 7 to diagnose the damage to the rolling bearing 1 without being affected by vibration in a low frequency caused by beats, and the like, vibration in a high frequency caused by friction, and the like, noise, turbulence vibration, and the like.

### Fifth Embodiment

The diagnosis unit 11 of the diagnostic device 7 diagnoses the damage to the rolling bearing 1 by using an evaluation index statistic obtained by performing statistical processing on a data group of evaluation indexes such as the evaluation speeds or the evaluation vibration calculated over a plurality of times. The evaluation index statistic is, for example, an average value, a median value, an effective value or a maximum value for the data group of the evaluation indexes. The diagnosis unit 11 provides a diagnosis indicating that damage has occurred to the rolling bearing 1, for example, in a case where the evaluation index statistic exceeds a threshold set in advance.

Each evaluation index such as an evaluation speed or evaluation vibration of each time calculated by the first calculation unit 10, and the like, may take an extremely large value as a result of, for example, the behavior sensor 8 capturing unexpected turbulence vibration, or the like, which is irrelevant to the damage of the rolling bearing 1. Concerning this, the diagnosis unit 11 performs diagnosis using the evaluation index statistic such as the average value, the median value, the effective value, and the like, obtained by performing statistical processing on the data group of the evaluation indexes, and thus, the diagnostic device 7 can perform diagnosis without being affected by an unexpected event that is irrelevant to the damage of the rolling bearing 1.

Further, for example, the evaluation index such as the evaluation speed and the evaluation vibration may become large with low frequency in a stage in which the damage of the rolling bearing 1 is small. Concerning this, the diagnosis unit 11 performs diagnosis using the evaluation index statistic such as the maximum value obtained by performing statistical processing on the data group of the evaluation indexes, and thus, the diagnostic device 7 can diagnose occurrence of the damage in a small stage earlier.

Further, for example, the evaluation index such as the evaluation speed and the evaluation vibration may rapidly change in a condition where the damage of the rolling bearing 1 rapidly progresses. Concerning this, the diagnosis unit performs diagnosis using the evaluation index statistic such as a standard deviation value or a variance value obtained by performing statistical processing on the data group of the evaluation indexes, and thus, the diagnostic device 7 can further diagnose a progress condition of the damage.

### Sixth Embodiment

The diagnosis unit 11 of the diagnostic device 7 diagnoses the damage to the rolling bearing 1 based on a cyclic change of the evaluation index such as the evaluation speed or the evaluation vibration which is continuously calculated to obtain temporally successive evaluation speeds or evaluation vibration.

For example, in the time-series data of the evaluation index calculated by the diagnosis unit 11, and the like, the evaluation index becomes large at a timing at which the rolling element 4 passes through the damaged portion 100 and substantially coincides with the cycle Tr of the characteristic vibration determined by the specifications of the rolling bearing 1. On the other hand, the cycle of the rolling element 4 passing through the damaged portion 100 is determined by expression (1) to expression (3) using a position where the damaged portion 100 has occurred, a dimension of the rolling bearing 1, a rotation speed of the rotation shaft 5, and the like. Thus, the diagnosis unit 11 can determine a position among the inner ring 2, the outer ring 3 or the rolling element 4 of the rolling bearing 1, where the damaged portion 100 has occurred from the cycle, the frequency, or the like, in which the evaluation index becomes large, based on the dimension and the rotation speed of the rolling bearing 1.

Further, the diagnosis unit 11 may diagnose the size of the damaged portion 100 based on the evaluation index in the cycle in which the evaluation index becomes large. This enables the diagnosis unit 11 to diagnose the size of the damaged portion 100 with high accuracy without being affected by noise such as turbulence vibration, and the like. The diagnosis unit 11 may, for example, diagnose a position where the damaged portion 100 has occurred from a frequency band in which the spectrum is large for frequency analysis data obtained by performing frequency analysis on the time-series data of the evaluation index. The diagnosis unit 11 can diagnose the size of the damaged portion 100 with high accuracy without being affected by noise such as turbulence vibration, for example, by diagnosing the size of the damaged portion 100 from a magnitude of the spectrum in a specific frequency band.

### Seventh Embodiment

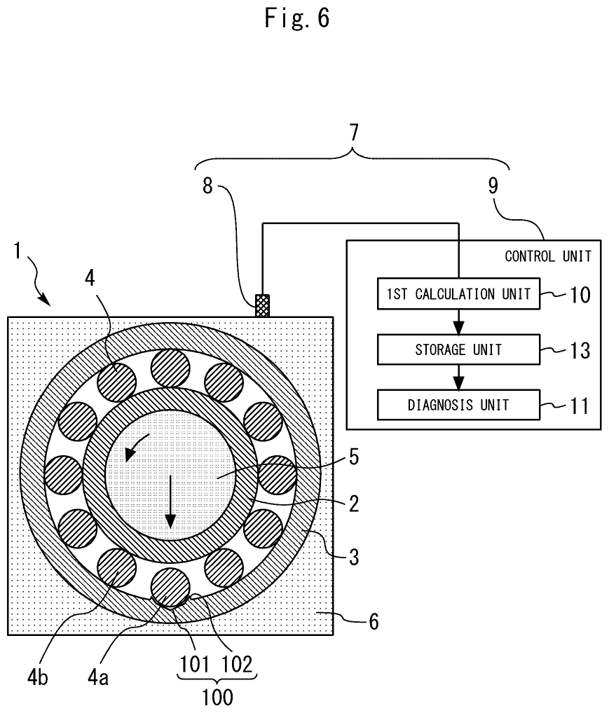

FIG. 6 is a configuration diagram of a rolling bearing according to a seventh embodiment.

The control unit 9 of the diagnostic device 7 of the rolling bearing 1 includes the first calculation unit 10, a storage unit 13 and the diagnosis unit 11.

The storage unit 13 is a portion having a function of storing information. The storage unit 13 accumulates and stores the calculated evaluation index. The storage unit 13 stores the evaluation indexes, for example, as time-series data. The storage unit 13, for example, stores the time-series data of the evaluation speed as the evaluation index. In a case where the diagnostic device 7 calculates the evaluation vibration as the evaluation index, the storage unit 13 may store time-series data of one or both of the evaluation speed and the evaluation vibration as the evaluation index. The storage unit 13 stores a temporal change of the evaluation index by storing the evaluation index as the time-series data. Further, the storage unit 13 may, for example, store a change amount such as a time differential value of the evaluation index calculated by the diagnosis unit 11, and the like.

Here, in rotation equipment in which a plurality of rolling bearings 1 with different specification conditions such as a size and a rotation speed is provided, even if sizes of damages occurring to the respective rolling bearings 1 are the same, the evaluation index such as the evaluation speed and the evaluation vibration may take different values depending on a difference in use condition. For example, the evaluation speed and the evaluation vibration for damage of the same degree tend to increase as the size and the rotation speed of the rolling bearing 1 are larger.

The diagnosis unit 11 diagnoses the damage to the rolling bearing 1 based on the information stored in the storage unit 13. The diagnosis unit 11, for example, calculates a first-order differential value of the evaluation index that is a temporal change rate of the evaluation index and diagnoses a damage condition from the first-order differential value of the evaluation index. By this means, the diagnosis unit 11 diagnoses the damage condition based on the change rate of the evaluation index, so that it is possible to diagnose the damage to the rolling bearings 1 with different specification conditions with higher accuracy.

Further, the diagnosis unit 11 may estimate a remaining lifespan until the evaluation index reaches a threshold that is a lifespan of the rolling bearing 1 based on the time-series data of the evaluation index, and the like, stored in the storage unit 13. This enables the diagnostic device 7 to determine an appropriate replacement time or maintenance check time of the rolling bearing 1. In this manner, the diagnostic device 7 can contribute to labor saving of maintenance and long-term stable operation of the rolling bearing 1, peripheral equipment of the rolling bearing 1, and the whole rotation equipment in which the rolling bearing 1 is provided.

### Eighth Embodiment

The rolling bearing 1 includes the inner ring 2, the outer ring 3, the plurality of rolling elements 4, the rotation shaft 5, and the diagnostic device 7.

Typically, the rolling bearing is a portion to which the largest load is applied in the rotation equipment and that is likely to break down first. If damage occurs to the rolling bearing, there is a case where the damage may become large at an accelerated rate as a result of stress around the damage becoming large. If the damage becomes large, behavior of the whole rotation equipment including the rotation shaft becomes unstable, which can lead to damage to peripheral equipment and the rotation shaft of the rolling bearing, a gear and a coupling, a stator, a housing, a frame, or the like.

Concerning this, the rolling bearing 1 can diagnose damage to the rolling bearing 1 and rotation equipment in which the rolling bearing 1 is provided with high accuracy by the attached diagnostic device 7. This makes it possible to prevent in advance a failure of peripheral equipment of the rolling bearing 1 and the whole rotation equipment in which the rolling bearing 1 is provided as well as the rolling bearing 1 itself.

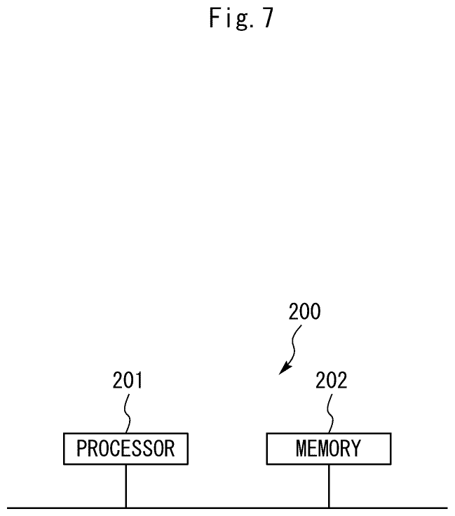

FIG. 7 is a diagram illustrating an example of a hardware configuration of the control unit of the diagnostic device according to any one of the first to the eighth embodiments.

The function of the control unit 9 can be implemented by a control circuit 200 illustrated in FIG. 7, that is, a processor 201 and a memory 202. Examples of the processor 201 can include a CPU (also referred to as a central processing unit, a processing unit, an arithmetic operation device, a microprocessor, a microcomputer, a processor, or a digital signal processor (DSP)), a system large scale integration (LSI), and the like. Examples of the memory 202 can include a random access memory (RAM), a read only memory (ROM), and the like.

The function of the control unit 9 can be implemented by the processor 201 reading a control program that is a program for causing the control unit 9 to execute processing from the memory 202 that stores the control program and executing the control program. Further, the control program can be regarded as a program for causing a computer to execute a control method of the diagnostic device 7 in the control unit 9. The control program to be executed by the control unit 9 has a module configuration in which various kinds of processing are modularized, for example, processing of calculating the evaluation speed based on the signal acquired from the behavior sensor 8, processing of calculating an acceleration overall value, processing of judging whether or not damage has occurred, processing of diagnosing a damage condition, and the like. These modules are loaded on a main memory device and generated on the main memory device.

The memory 202 is used as a temporary memory when the processor 201 executes various kinds of processing. Further, in the seventh embodiments, the memory 202 is used as the storage unit 13 that stores the evaluation speed or the evaluation index such as the evaluation vibration as time-series data.

The control program to be executed by the processor 201 may be stored in a computer-readable storage medium as a file in an installable or executable format and provided as a computer program product. Further, the control program to be executed by the processor 201 may be provided to the control unit 9 of the diagnostic device 7 via a network such as the Internet.

Further, the control unit 9 may be implemented with dedicated hardware. Still further, some of the functions of the control unit 9 may be implemented by dedicated hardware, and the other may be implemented by software or firmware.

While an example of a configuration where the inner ring 2 rotates together with the rotation shaft 5 has been described for the rolling bearing 1 according to any one of the first to the eighth embodiments, it is also possible to employ a configuration where a shaft integrated with the inner ring 2 is fixed in rotation. Further, while an example of a configuration where the outer ring 3 is fixed in the housing 6 has been described, it is also possible to employ a configuration where the outer ring 3 rotates in an integrated manner with the rotation shaft 5 provided outside the outer ring 3. Furthermore, the rolling bearing 1 may be configured such that the inner ring 2 and the outer ring 3 both rotate integrally with separate rotating shafts 5.

For the rolling bearing 1 according to any one of the first to the eighth embodiments, the number and arrangement of the rolling elements 4 are not limited to the number and arrangement illustrated in FIG. 1, or the like.

While an example of a condition in which there is one damaged portion 100 has been described for the rolling bearing 1 or the diagnostic device 7 according to any one of the first to the eighth embodiments, there may be two or more damaged portions 100. Further, while an example of a case where the damaged portion 100 has occurred in the outer ring 3 has been described, the damaged portion 100 may occur in the inner ring 2 or the rolling element 4.

While an example of a configuration where there is one behavior sensor 8 has been described for the rolling bearing 1 or the diagnostic device 7 according to any one of the first to the eighth embodiments, there may be two or more behavior sensors 8. Further, a position and a shape of the behavior sensor 8 are not limited to the examples described above.

The diagnostic device 7 according to any one of the first to the eighth embodiments described above can be applied to any of the rolling bearing 1 to which a lubricant such as grease is supplied, the rolling bearing 1 to which a lubricant such as grease is not supplied, the rolling bearing 1 that is in rotation operation, and the rolling bearing 1 that stops rotation.

Note that in the present specification, expressions representing directions such as the “shaft direction”, the “radial direction”, the “circumferential direction”, the “rotation direction”, the “load direction”, and the “anti-load direction” not only include strictly indicated directions but also include directions in which substantially the same functions can be obtained. Further, in the present specification, expressions such as “comprise”, “provide”, “include” and “have” do not mean exclusive expressions that exclude existence of other components.

While various illustrative embodiments and examples are described in the present disclosure, various features, aspects and functions described in one or a plurality of embodiments are not limited to application in a specific embodiment, but can be applied to the embodiment alone or in various combinations. Thus, an infinite number of modifications which are not described are assumed within the scope of the technique of the present disclosure. It is assumed in one example that the modifications include modification, addition or omission of at least one component, and further, extraction of at least one component and combination of the component with components in other embodiments. Further, the configurations described above in the embodiments can be combined with another publicly known techniques. In other words, part of the configurations described above in the embodiments can be omitted or changed within a range not deviating from the gist.

### INDUSTRIAL APPLICABILITY

The diagnostic device according to the present disclosure can be applied to a rolling bearing. The rolling bearing according to the present disclosure can be applied to rotation equipment.

### REFERENCE SIGNS LIST

1 Rolling bearing, 2 Inner ring, 3 Outer ring, 4, 4a, 4b Rolling element, 5 Rotation shaft, 6 Housing, 7 Diagnostic device, 8 Behavior sensor, 9 Control unit, 10 First calculation unit, 11 Diagnosis unit, 12 Second calculation unit, 13 Storage unit, 100 Damaged portion, 101 Recessed portion, 102 Damaged corner portion, 200 Control circuit, 201 Processor, 202 Memory

1-13. (canceled)

14. A diagnostic device that diagnoses a rolling bearing which comprises:
an inner ring;
an outer ring arranged concentrically with the inner ring; and
a plurality of rolling elements arranged between a raceway surface of the outer ring and a raceway surface of the inner ring, and each rolling in association with rotation of the inner ring, rotation of the outer ring, or rotation of both the inner ring and the outer ring,
the diagnostic device comprising:
a behavior sensor that is provided on a housing that holds the inner ring or the outer ring and measures behavior of the housing; and
processing circuitry
to calculate an evaluation speed based on information acquired by the behavior sensor, the evaluation speed being a total value of a maximum speed component in a direction of a load acting from a rotation shaft, which rotates in an integrated manner with the inner ring or the outer ring, and a maximum speed component in a direction opposite to the direction of the load acting from the rotation shaft, within a period equal to or longer than a cycle of characteristic vibration determined by specifications of the rolling bearing and a rotation speed of the rotation shaft, and
to diagnose damage to the rolling bearing by using an evaluation index based on the evaluation speed.

15. The diagnostic device according to claim 14, wherein the behavior sensor is an acceleration sensor, and
the processing circuitry calculates the evaluation speed using a time-series data of a speed obtained by performing time integration on a time-series data of an acceleration that is an output signal from the behavior sensor.

16. The diagnostic device according to claim 14, wherein the behavior sensor is a displacement sensor, and
the processing circuitry calculates the evaluation speed using a time-series data of a speed obtained by differentiating, with respect to time, a time-series data of a displacement that is an output signal from the behavior sensor.

17. The diagnostic device according to claim 14, wherein the behavior sensor is a speed sensor, and
the processing circuitry calculates the evaluation speed using a time-series data of a speed that is an output signal from the behavior sensor.

18. The diagnostic device according to claim 15, wherein the processing circuitry calculates the evaluation speed using a time-series data obtained by performing a slope correction on the time-series data of the speed.

19. The diagnostic device according to claim 15, wherein the processing circuitry calculates the evaluation speed using a time-series data obtained by performing a frequency filter processing on one or both of the time-series data that is the output signal from the behavior sensor and the time-series data of the speed.

20. The diagnostic device according to claim 14, wherein the processing circuitry diagnoses the damage to the rolling bearing by using an evaluation index statistic obtained by performing a statistical processing on a data group of the evaluation index calculated over a plurality of times.

21. The diagnostic device according to claim 14, wherein the processing circuitry diagnoses the damage to the rolling bearing based on a cyclic change of the evaluation index that is continuously calculated.

22. The diagnostic device according to claim 21, wherein the processing circuitry diagnoses the damage to the rolling bearing using frequency analysis data of time-series data of the evaluation index that is continuously calculated.

23. The diagnostic device according to claim 14, wherein the processing circuitry accumulates and stores the evaluation index or a change amount of the evaluation index, and
the processing circuitry calculates a maintenance check time of the rolling bearing based on information stored in the processing circuitry.

24. A rolling bearing comprising:
an inner ring;
an outer ring arranged concentrically with the inner ring;
a plurality of rolling elements arranged between a raceway surface of the outer ring and a raceway surface of the inner ring and each rolling in association with rotation of the inner ring, rotation of the outer ring, or rotation of both the inner ring and the outer ring; and
the diagnostic device according to claim 14.

25. A diagnostic device that diagnoses a rolling bearing which comprises:
an inner ring;
an outer ring arranged concentrically with the inner ring; and
a plurality of rolling elements arranged between a raceway surface of the outer ring and a raceway surface of the inner ring, and each rolling in association with rotation of the inner ring, rotation of the outer ring, or rotation of both the inner ring and the outer ring,
the diagnostic device comprising:
a behavior sensor that is provided on a housing that holds the inner ring or the outer ring and measures behavior of the housing; and
processing circuitry
to calculate an evaluation speed based on information acquired by the behavior sensor within a period equal to or longer than a cycle of characteristic vibration determined by specifications of the rolling bearing and a rotation speed of the rotation shaft, which rotates in an integrated manner with the inner ring or the outer ring, the evaluation speed being a total value of a maximum speed component of a vibration in a direction of a load acting from the rotation shaft and a maximum speed component of the vibration in a direction opposite to the direction of the load acting from the rotation shaft, and
to diagnose damage to the rolling bearing by using an evaluation index based on the evaluation speed.

26. The diagnostic device according to claim 25, wherein the behavior sensor is an acceleration sensor, and
the processing circuitry calculates the evaluation speed using a time-series data of a speed obtained by performing time integration on a time-series data of an acceleration that is an output signal from the behavior sensor.

27. The diagnostic device according to claim 25, wherein the behavior sensor is a displacement sensor, and
the processing circuitry calculates the evaluation speed using a time-series data of a speed obtained by differentiating, with respect to time, a time-series data of a displacement that is an output signal from the behavior sensor.

28. The diagnostic device according to claim 25, wherein the behavior sensor is a speed sensor, and
the processing circuitry calculates the evaluation speed using a time-series data of a speed that is an output signal from the behavior sensor.

29. The diagnostic device according to claim 26, wherein the processing circuitry calculates the evaluation speed using a time-series data obtained by performing a slope correction on the time-series data of the speed.

30. The diagnostic device according to claim 26, wherein the processing circuitry calculates the evaluation speed using a time-series data obtained by performing a frequency filter processing on one or both of the time-series data that is the output signal from the behavior sensor and the time-series data of the speed.

31. The diagnostic device according to claim 25, wherein the processing circuitry diagnoses the damage to the rolling bearing by using an evaluation index statistic obtained by performing a statistical processing on a data group of the evaluation index calculated over a plurality of times.

32. The diagnostic device according to claim 25, wherein the processing circuitry diagnoses the damage to the rolling bearing based on a cyclic change of the evaluation index that is continuously calculated.

33. The diagnostic device according to claim 32, wherein the processing circuitry diagnoses the damage to the rolling bearing using frequency analysis data of time-series data of the evaluation index that is continuously calculated.

34. The diagnostic device according to claim 25, wherein the processing circuitry accumulates and stores the evaluation index or a change amount of the evaluation index, and
the processing circuitry calculates a maintenance check time of the rolling bearing based on information stored in the processing circuitry.

35. A rolling bearing comprising:
an inner ring;
an outer ring arranged concentrically with the inner ring;
a plurality of rolling elements arranged between a raceway surface of the outer ring and a raceway surface of the inner ring and each rolling in association with rotation of the inner ring, rotation of the outer ring, or rotation of both the inner ring and the outer ring; and
the diagnostic device according to claim 25.
